(19) United States
(12) Patent Application Publication
(10) Pub. No.: US 2010/0232041 A1
(43) Pub. Date: Sep. 16, 2010

(54) IMAGING LENS SYSTEM WITH SMALL APERTURE VALUE AND COMPACT SIZE AND IMAGING MODULE HAVING SAME

(75) Inventors: CHUN-YI YIN, Tu-Cheng (TW); CHUN-HSIANG HUANG, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/430,064

(22) Filed: Apr. 24, 2009

(30) Foreign Application Priority Data
Mar. 10, 2009 (CN) 200910300781.5

(51) Int. Cl. G02B 9/12

(52) U.S. Cl. 359/791

(57) ABSTRACT

An imaging module includes an imaging lens system and an image sensor. The imaging lens system includes a first lens, a second lens, and a third lens. The imaging module satisfies the formulae, 2.4<S1/D1<3.0, 0.3<R1/F<0.7, wherein S1 is the effective diameter of the first surface S1 of the first lens, D1 is the distance from the object side surface S1 to the image side surface S2 of the first lens along the optic axis, R1 is the radius of curvature of the object side surface S1 of the first lens, and F is the focal length of the imaging lens system.

### BACKGROUND

1. Technical Field

The disclosure relates to imaging modules and, particularly, to an imaging lens system providing a small aperture value and a reduced overall length, and an imaging lens module having the same.

2. Description of Related Art

To optimize image quality, small imaging modules for use in thin devices, such as mobile phones or personal digital assistant (PDA), must employ an imaging lens system with a small aperture value and a small overall length (the distance between the object-side surface of the imaging lens system and the image plane of the imaging module). However, in optical design of an imaging lens system, reducing the aperture value thereof commonly increases overall lens thereof.

Therefore, it is desirable to provide an imaging lens system and an imaging module having the same which can overcome the described limitations.

### BRIEF DESCRIPTION OF THE DRAWINGS

FIG. 1 is a schematic view of an imaging module in accordance with an exemplary embodiment.

FIG. 2 is a field curvature graph of the imaging module of FIG. 1, according to a first exemplary embodiment.

FIG. 3 is a distortion graph of the imaging module of FIG. 1, according to the first exemplary embodiment.

FIG. 4 is a spherical aberration graph of the imaging module of FIG. 1, according to the first exemplary embodiment.

FIG. 5 is a field curvature graph of the imaging module of FIG. 1, according to a second exemplary embodiment.

FIG. 6 is a distortion graph of the imaging module of FIG. 1, according to the second exemplary embodiment.

FIG. 7 is a spherical aberration graph of the imaging module of FIG. 1, according to the second exemplary embodiment.

### DETAILED DESCRIPTION

Embodiments of the present imaging module and imaging lens system will now be described in detail with reference to the drawings.

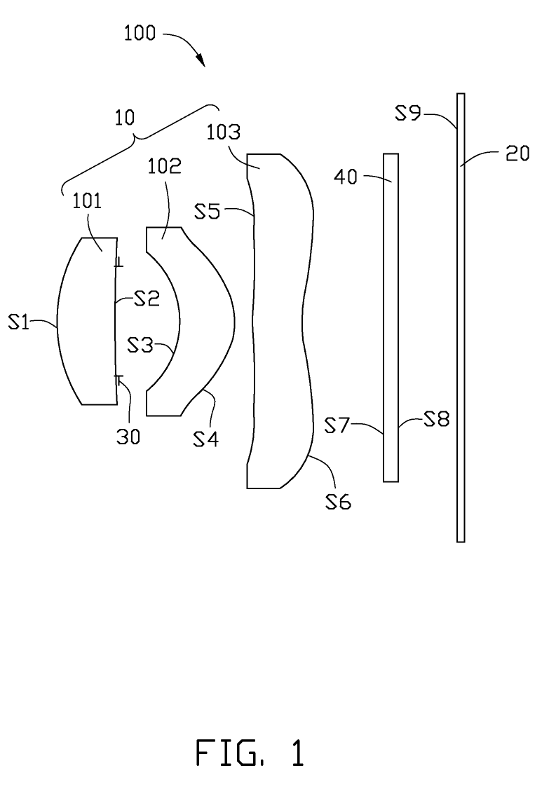

Referring to FIG. 1, the imaging module 100, according to an exemplary embodiment, is shown. The imaging module 100 includes an imaging lens system 10 and an image sensor 20. The image sensor 20 is aligned with the imaging lens system 10 and positioned at the image side of the imaging lens system 10. The imaging lens system 10 includes, in the order from the object side to the image side thereof, a first lens 101, a second lens 102, and a third lens 103. The first lens 101 and the second lens 102 provide positive refraction power. The third lens 103 provides negative refraction power. The image sensor 20 includes a sensing surface S9 facing the imaging lens system 10.

The first lens 101 includes a convex first surface S1 facing the object side of the image lens system 10, and a concave second surface S2 facing the image side of the image lens system 10, thereby defining a meniscus shape of the first lens 101. The first and second surfaces S1, S2 are aspherical.

The second lens 102 includes a concave third surface S3 facing the object side of the image lens system 10, and a convex fourth surface S4 facing the image side of the image lens system 10, thereby defining a meniscus shape of the second lens 102. The third and fourth surfaces S3, S4 are aspherical.

The third lens 103 includes a convex fifth surface S5 facing the object side of the image lens system 10, and a concave sixth surface S6 facing the image side of the image lens system 10, thereby defining a meniscus shape of the third lens 103. The fifth and sixth surfaces S5, S6 are aspherical.

In order to obtain a the lens system 100 that has a small aperture and a short overall length, the imaging module 100 satisfies the formulas:

2.4<L1/D1<3.0, and (1)

0.3<R1/F<0.7, (2)

where L1 is the effective diameter of the first surface S1 of the first lens 101, D1 is the distance from the first surface S1 to the second surface S2 on the optical axis of the imaging lens system 10, R1 is the radius of curvature of the first surface S1, and F is the focal length of the imaging lens system 10.

Formula (1) is for reducing the aperture value of the imaging module 100 to obtain a desirably small value of the imaging module 100. Formula (2) is for reducing overall length of the lens system 100.

The imaging module 100 further satisfies the formula: (3) 1.4<R2/F1<2.2, where F1 is the focal length of the first lens 101, and R2 is the radius of curvature of the second surface S2. Formula (3) is for correcting the distortion and the spherical aberration of the imaging module 100.

The imaging module 100 further satisfies the formula: (4) −0.5<R3/F2<R4/F2<−0.1, where R3 is the radius of curvature of the third surface S3 of the second lens 102, R4 is the radius of curvature of the fourth surface S4 of the second lens 102, and F2 is focal length of the second lens 102. Formula (4) is for correcting the field curvature of the imaging module 100.

The imaging module 100 further satisfies the formula: (5) −1<R5/F3<−0.5, where R5 is the radius of curvature of the fifth surface S5, F3 is the focal length of the third lens 103. Formula (5) is for correcting the coma aberration and the astigmation of the imaging module 100.

The imaging module 100 further satisfies the formula: (6) −0.5<R6/F3<−0.1, where R6 is the radius of curvature of the sixth surface S6 of the third lens 103, F3 is the focal length of the third lens 103. Formula (6) is for correcting the distortion and the astigmation of the imaging module 100.

The imaging module 100 further satisfies the formula: (7) 45<Vd2<60, where Vd2 is the Abbe number of the second lens 102. Formula (7) is for correcting the lateral color of the imaging module 100.

The imaging module 100 further includes an aperture stop 30. The aperture stop 30 is positioned between the first lens 101 and the second lens 102 and is configured to prevent excessive off-axis light rays entering the second lens 102. Also, positioning the aperture stop 30 between the first lens 101 and the second lens 102 is also beneficial for reducing the overall length of the imaging module 100.

The imaging module 100 also includes a cover glass 40, which is positioned between the image lens system 10 and the image sensor 20 for protecting the sensing area (not labeled) of the image sensor 20. The cover glass 40 includes an object side surface S7 and an image surface S8.

The four lenses 101, 102, 103 can be made of plastic, to reduce costs, and all have two aspherical surfaces (i.e., the aspherical object-side surface and the aspherical image-side surface) to efficiently correct aberration. The aspherical surface is shaped according to the formula:

$$x = \frac{{ch}^{2}}{1 + \sqrt{1 - ( k + 1 ) {c}^{2} {h}^{2}}} + \sum {Aih}^{i} ,$$

where h is a height from the optical axis of the imaging module 100 to the aspherical surface, c is a vertex curvature, k is a conic constant, and Ai are i-th order correction coefficients of the aspherical surfaces.

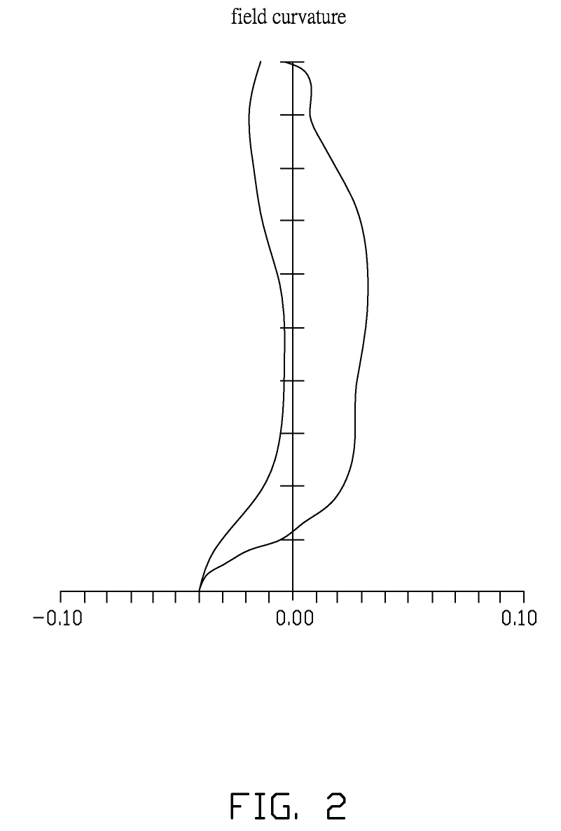

Detailed examples of the imaging module 100 are given below in company with FIGS. 2-7, but it should be noted that the imaging module 100 is not limited by these examples. Listed below are the symbols used in these detailed examples:
Z: aperture value;
L: overall length;
R: radius of curvature;
D: distance between surfaces on the optical axis of the imaging module 100;
Nd: refractive index of lens; and
Vd: Abbe constant.
   When capturing an image, incident light enters the imaging lens system 10, sequentially transmits through four lenses 101, 102, 103, the cover glass 40, and is finally focused onto the image sensor 20.

### EXAMPLE 1

Tables 1, 2 show the lens data of Example 1, wherein Z=2.0, L=2.5 mm.

TABLE 1

| surface | R (mm) | D (mm) | Nd | Vd |
|---|---|---|---|---|
| S1 | 0.830814 | 0.351481 | 1.54347 | 56.8 |
| S2 | 3.444337 | 0.020895 | | |
| S3 | −0.58098 | 0.333402 | 1.54347 | 56.8 |
| S4 | −0.42483 | 0.03 | | |
| S5 | 2.04682 | 0.3 | 1.531131 | 55.7539 |
| S6 | 0.773161 | 0.093683 | | |
| S7 | infinite | 0.3 | 1.5168 | 64.167 |
| S8 | infinite | 0.25 | — | — |
| S9 | infinite | 0.4 | — | — |

TABLE 2

| Surface | Aspherical coefficient |
|---|---|
| S1 | k = −0.2726; A4 = −0.1401; A6 = 3.398219; A8 = −27.1252; |
| | A10 = 101.1295 |
| S2 | k = −34.8213; A4 = 0.206078; A6 = −9.27882; A8 = 150.4804; |
| | A10 = −1301.29 |
| S3 | k = 0.56322; A4 = −0.68516; A6 = 4.330514; A8 = −112.67; |
| | A10 = 877.2502 |
| S4 | k = −0.48504; A4 = 0.885204; A6 = 2.663011; A8 = −25.854; |
| | A10 = 91.77578 |
| S5 | k = −300; A4 = −0.17157; A6 = 0.384812; A8 = −0.53928; |
| | A10 = −0.09251 |
| S6 | k = −15.4332; A4 = −0.64845; A6 = 1.358167; A8 = −2.33853; |
| | A10 = 2.044404 |

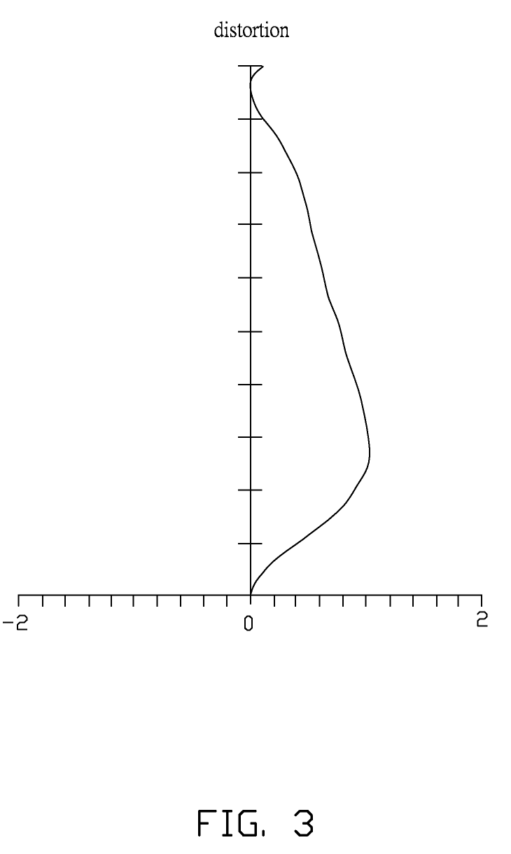

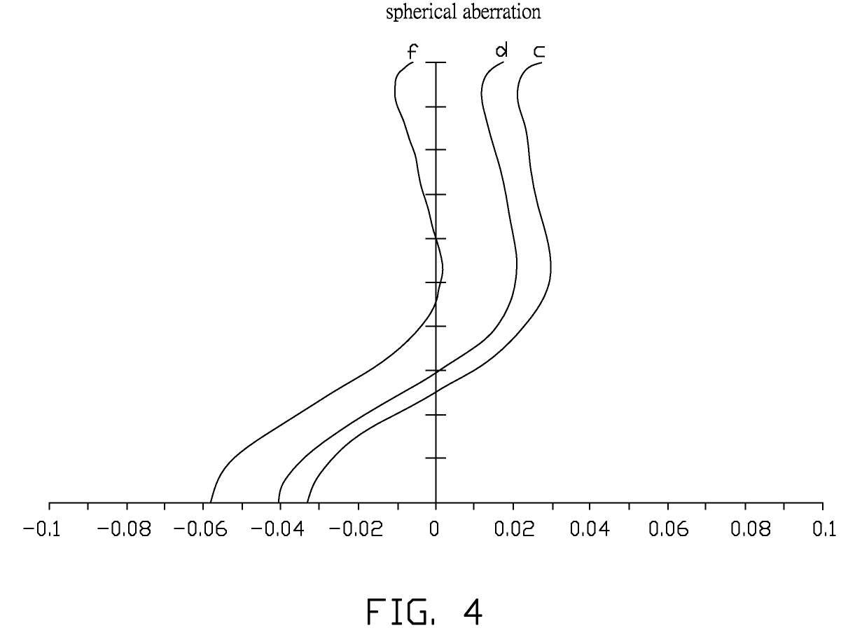

The spherical aberration graph, the field curvature graph, and the distortion graph of the lens system 100 of Example 1 are respectively shown in FIGS. 2˜4. Spherical aberrations of line f (λ=486 nm) and line d (λ=587 nm) and line c (λ=656 nm) are shown in FIG. 2. Generally, spherical aberration of visible light (with a wavelength between 400˜700 nm) of the lens system 100 in the Example 1 is within a range of −0.05 mm to 0.05 mm. The sagittal field curvature and tangential field curvature shown in FIG. 3 are kept within a range of −0.10 mm to 0.10 mm. The distortion in FIG. 4 falls within a range of −2% to 2%. Obviously, the spherical aberration, field curvature, and distortion are well controlled in the Example 1 of the lens system 100.

### EXAMPLE 2

Tables 3, 4 show the lens data of EXAMPLE 2, wherein Z=2.0, L=2.4 mm.

TABLE 3

| surface | R (mm) | D (mm) | Nd | Vd |
|---|---|---|---|---|
| S1 | 0.858896 | 0.360701 | 1.54347 | 56.8 |
| S2 | 3.473341 | 0.024232 | — | — |
| S3 | −0.60056 | 0.357383 | 1.54347 | 56.8 |
| S4 | −0.44954 | 0.03 | — | — |
| S5 | 2.017584 | 0.3 | 1.531131 | 55.7539 |
| S6 | 0.902934 | 0.094177 | — | — |
| S7 | infinite | 0.3 | 1.5168 | 64.167 |
| S8 | infinite | 0.25 | — | — |
| S9 | infinite | 0.4 | — | — |

TABLE 4

| Surface | Aspherical coefficient |
|---|---|
| S1 | k = 0.00711; A4 = −0.16641; A6 = 2.714862; A8 = −19.4162; |
| | A10 = 64.21143 |
| S2 | k = 50.84214; A4 = −0.0504; A6 = −6.74381; A8 = 64.71914; |
| | A10 = −403.97 |
| S3 | k = −0.00322; A4 = −1.4192; A6 = 8.013139; A8 = −139.132; |
| | A10 = 783.3503 |
| S4 | k = −0.43604; A4 = 0.402069; A6 = 4.917599; A8 = −20.9501; |
| | A10 = 14.68617 |
| S5 | k = −300; A4 = 0.069958; A6 = −0.02691; A8 = −0.9517; |
| | A10 = 1.4348 |
| S6 | k = −18.1809; A4 = −0.44978; A6 = 0.848769; A8 = −1.4438; |
| | A10 = 1.04029 |

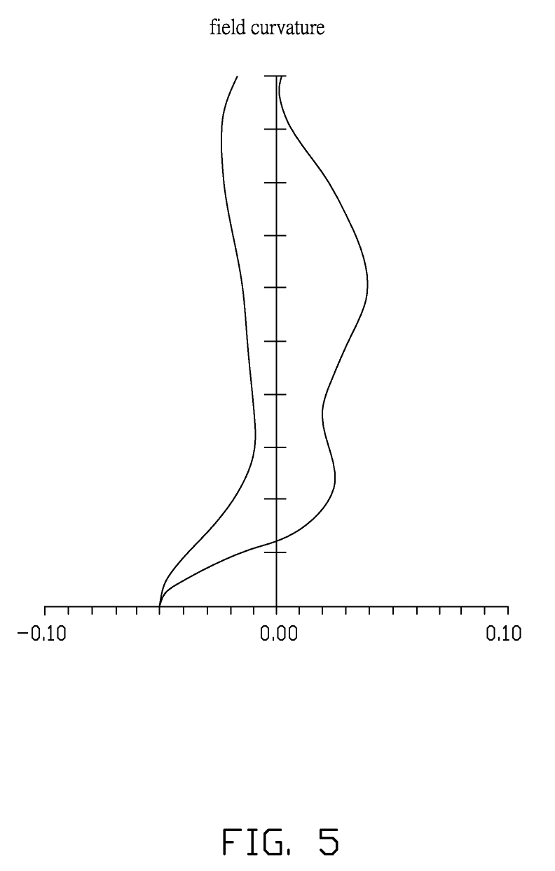

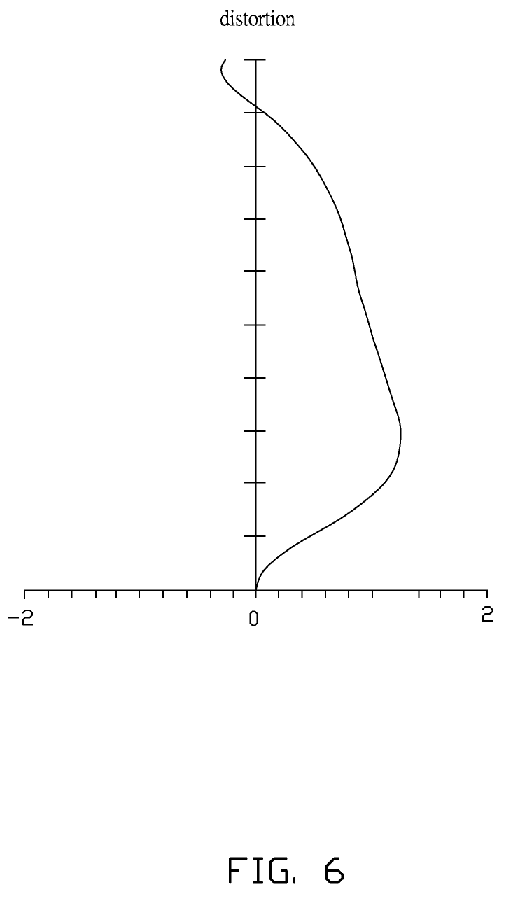

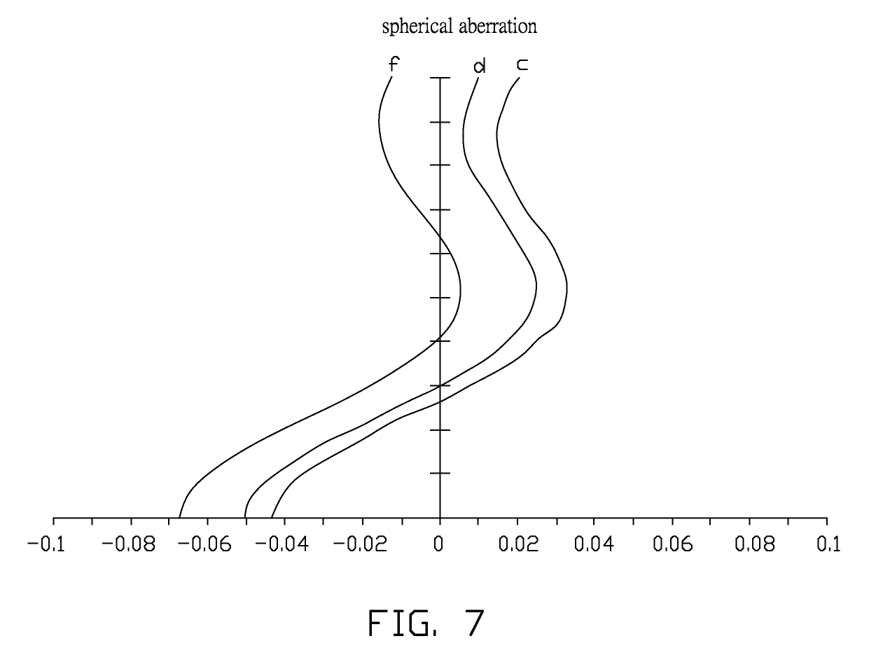

The spherical aberration graph, the field curvature graph, and the distortion graph of the lens system 100 of Example 2 are respectively shown in FIGS. 5˜7. Spherical aberrations of line f (λ=486 nm) and line d (λ=587 nm) and line c (λ=656 nm) are shown in FIG. 5. Generally, spherical aberration of visible light (with a wavelength between 400˜700 nm) of the lens system 100 in the Example 1 is within a range of −0.05 mm to 0.05 mm. The sagittal field curvature and tangential field curvature shown in FIG. 6 are kept within a range of −0.10 mm to 0.10 mm. The distortion in FIG. 7 falls within a range of −2% to 2%. Obviously, the spherical aberration, field curvature, and distortion are well controlled in the Example 2 of the lens system 100.

In summary, according to examples 1-2, though the aperture value and the overall length of the imaging module 100 are reduced, aberrations are controlled/corrected within an acceptable range.

It will be understood that the above particular embodiments and methods are shown and described by way of illustration only. The principles and the features of the disclosure may be employed in various and numerous embodiment thereof without departing from the scope of the invention as claimed. The above-described embodiments illustrate the scope of the invention but do not restrict the scope of the invention.

What is claimed is:

1. An imaging module comprising,
an imaging lens system comprising, in the order from the object side to the image side thereof, a first lens of positive refraction power, a second lens of positive refraction power, and a third lens of negative refraction power; and
an image sensor placed aligned with the imaging lens system and placed at the image side of the imaging lens system,
wherein the imaging module satisfying the formulas:
2.4<L1/D1<3.0, and
0.3<R1/F<0.7,
wherein L1 is the effective diameter of the object surface of the first lens, D1 is the distance from the object side surface to the image side surface of the first lens along the optic axis, R1 is the radius of curvature of the object side surface of the first lens, F is the focal length of the imaging lens system.

2. The imaging module as claimed in claim 1, wherein the imaging module further satisfying the formula:
1.4<R2/F1<2.2,
wherein F1 is the focal length of the first lens, and R2 is the radius of curvature of the image side surface of the first lens.

3. The imaging module as claimed in claim 1, wherein the imaging module further satisfying the formula:
−0.5<R3/F2<R4/F2<−0.1,
wherein R3 is the radius of curvature of the object side surface of the second lens, R4 is the radius of curvature of the image side surface of the second lens, and F2 is focal length of the second lens.

4. The imaging module as claimed in claim 1, wherein the imaging module further satisfies the formula:
−1<R5/F3<−0.5,
wherein R5 is the radius of curvature of the object side surface of the third lens, and F3 is the focal length of the third lens.

5. The imaging module as claimed in claim 1, wherein the imaging module further satisfying the formula:
−0.5<R6/F3<−0.1,
wherein R6 is the radius of curvature of the image side surface of the third lens, and F3 is the focal length of the third lens.

6. The imaging module as claimed in claim 1, wherein the imaging module further satisfying the formula:
45<Vd2<60,
wherein Vd2 is the Abbe number of the second lens.

7. The imaging module as claimed in claim 1, wherein the first, second, and third lenses are aspherical lenses.

8. The imaging module as claimed in claim 1, wherein the imaging module further comprises an aperture stop disposed between the first lens and the second lens.

9. The imaging module as claimed in claim 1, wherein a cover glass is positioned between the image lens system and the image sensor for protecting a sensing area of the image sensor.

10. The imaging module as claimed in claim 1, wherein the first, second and third lenses are made of plastic.

11. An imaging lens system comprising, in this order from the object side to the image side thereof,
a first lens of positive refraction power, a second lens of positive refraction power, and a third lens of negative refraction power;
wherein the imaging lens system satisfying the formulas:
2.4<L1/D1<3.0, and
0.3<R1/F<0.7,
wherein L1 is the effective diameter of the object surface of the first lens, D1 is the distance from the object side surface to the image side surface of the first lens along the optic axis, R1 is the radius of curvature of the object side surface of the first lens, and F is the focal length of the imaging lens system.

12. The imaging lens system as claimed in claim 11, wherein the imaging lens system further satisfying the formula:
1.4<R2/F1<2.2,
wherein F1 is the focal length of the first lens, and R2 is the radius of curvature of the image side surface of the first lens.

13. The imaging lens system as claimed in claim 11, wherein the imaging lens system further satisfying the formula:
−0.5<R3/F2<R4/F2<−0.1,
wherein R3 is the radius of curvature of the object side surface of the second lens, R4 is the radius of curvature of the image side surface of the second lens, and F2 is focal length of the second lens.

14. The imaging lens system as claimed in claim 11, wherein the imaging lens system further satisfies the formula:
−1<R5/F3<−0.5,
wherein R5 is the radius of curvature of the object side surface of the third lens, and F3 is the focal length of the third lens.

15. The imaging lens system as claimed in claim 11, wherein the imaging lens system further satisfying the formula:
−0.5<R6/F3<−0.1,
wherein R6 is the radius of curvature of the image side surface of the third lens, and F3 is the focal length of the third lens.

16. The imaging lens system as claimed in claim 11, wherein the imaging lens system further satisfying the formula:
45<Vd2<60,
wherein Vd2 is the Abbe number of the second lens.

17. The imaging lens system as claimed in claim 11, wherein the first, second, and third lenses are aspherical lenses.

18. The imaging lens system as claimed in claim 11, wherein the first, second and third lenses are made of plastic.
